(19) United States
(12) Patent Application Publication
(10) Pub. No.: US 2006/0191411 A1
(43) Pub. Date: Aug. 31, 2006

(54) Water extraction apparatus and method

(76) Inventor: Neldon P. Johnson, Salem, UT (US)

Correspondence Address: J. David Nelson;NELSON, SNUFFER, DAHLE & POULSEN, P.C., 10885 South State Street, Sandy, UT, 84070, US

(21) Appl. No.: 11/069,160

(22) Filed: Feb. 28, 2005

(51) Int. Cl. B01D 53/14

(52) U.S. Cl. 95/187

(57) ABSTRACT

Apparatus and method for extracting water from air containing water vapor. A feed air assembly supplies air containing water vapor to a diff-user assembly in a reactive tank containing a reagent, preferably sulfuric acid, which absorbs the water vapor from the feed air. The reactive tank vents the dried air. A reagent solution line transmits reagent solution from the reactive tank to a recovery tank. A vacuum pump evaporates concentrated water vapor from the recovery tank and an extraction energy exchanger condenses the concentrated water vapor to liquid water.

### FIELD OF THE INVENTION

This invention is in the field of apparatuses and methods for the extraction of water from air and in particular in the field of apparatuses for the extraction of liquid water from air containing water vapor through the use of a chemical reagent.

### BACKGROUND OF THE INVENTION

In many settings and geographical areas, a scarcity of water, and, in particular a scarcity of potable water, results in the consideration of many alternatives for the development of sources of water. Air containing water vapor is one such source.

Even relatively dry desert air having a relative humidity of ten percent or less is a potential source for a huge quantity of water. The principal challenges that removing water from air with conventional technology presents are the large quantity of air that must be processed and the high energy requirements for condensing the water vapor. The heat of cooling and the heat of vaporization must be extracted from the air in order to condense the water vapor. The conventional approach is to pass the air through a heat exchanger which is cooled by the circulation of a refrigerant. With the relatively low concentration of water vapor in dryer settings where extraction of water from air is more likely to be considered, the low concentration results in the consumption of large amounts of energy for air handling and condensation.

It is an objective of the present invention to provide an apparatus and method for increasing the efficiency and decreasing the energy requirements for water extraction from air containing water vapor.

It is a further objective of the present invention to provide an apparatus and method for the extraction of water from air containing water vapor through the use of a chemical reagent to effect an increase in the concentration of water vapor.

It is a still further objective of the present invention to provide an apparatus and method for the extraction of water from air containing water vapor that accommodates the use of waste heat or the use of direct heat from a solar collector or other sources for a portion of the energy required for the extraction process.

It is a still further objective of the present invention to provide an apparatus and method for the extraction of potable water from raw water through the use of a chemical reagent and a vacuum to produce concentrated water vapor for condensation to potable water.

### SUMMARY OF THE INVENTION

For preferred embodiments, pressurized feed air from any source of air, including ambient atmosphere, containing water vapor is supplied to a reactive chamber containing a reagent, preferably sulfuric acid. The water vapor is absorbed from the pressurized feed air by reaction with the reagent and spent air with most of the water removed is discharged to atmosphere. Reagent solution is transmitted to a recovery chamber where concentrated water vapor is extracted from the reagent solution which is heated by recovery heat supplied from an energy source. The concentrated water vapor is extracted in a concentrated vapor zone created by a vacuum pump, which also pressurizes concentrated water vapor for an extraction energy exchanger which discharges extracted water. Heat of cooling and vaporization is extracted from the extraction energy exchanger by a heat exchange device. Concentrated reagent is re-circulated from the recovery chamber to the reactive chamber. The inventor prefers sulfuric acid as the reagent for the reactive chamber, because of its high water absorption capability, high vaporization temperature, high heat of vaporization, and relatively low cost.

For preferred embodiments, feed air from the ambient atmosphere is pulled into an air intake and is pressurized by intake blowers. Pressurized feed air is transmitted by a feed pipe from the intake blowers to a diffuser assembly which diffuses, distributes and mixes diffused feed air with reagent in a reactive chamber. Spent air, which is the diffused feed air with most of the water content of the feed air removed, is released from a reactive chamber vent. The spent air will generally have a relative humidity of less than one percent. The diffuser assembly is preferably located near the bottom of the reactive chamber. As an alternative to a diffuser assembly, mechanical mixing or other diffusion means for diffusing, mixing and distributing the pressurized feed air in the reactive chamber can be used. Reagent solution is transmitted to the reagent recovery chamber by a reactive chamber feed line.

A recovery vacuum pump which is connected to a concentrated vapor zone by a vacuum pipe imposes a vacuum on the recovery chamber liquid surface, which results in an accelerated vaporization rate for the water in the reagent solution. The inventor has found that a temperature ranging between 180° Fahrenheit and 200° Fahrenheit for the recovery chamber reagent solution is preferred for optimizing the vaporization of water from the reagent solution in the reagent recovery chamber, if sulfuric acid is used for the reagent.

A recovery chamber temperature sensor is used to activate a recovery chamber heat assembly which includes a recovery chamber temperature control pump which pumps reagent solution from the recovery chamber by a recovery heat line through a recovery heat exchanger. The temperature sensor can also be used to control the rate of supply of recovery heat by a heat supply line from an energy source. The temperature of the recovery chamber is maintained in a desired temperature range by controlling the rate of circulation of the reagent solution through the recovery chamber heat assembly and the rate of energy supply to the recovery heat assembly.

The vacuum pump discharges pressurized concentrated water vapor to a concentrated vapor line which carries the pressurized concentrated water vapor to an extraction energy exchanger which condenses water from the pressurized concentrated water vapor.

As water is vaporized from the recovery chamber liquid surface the concentration of the reagent in the recovery chamber is increased. Re-circulated reagent is returned by a reagent re-circulation pump through a reagent re-circulation line to the reactive chamber to maintain hydraulic balance between the reactive chamber and the recovery chamber and to maintain the concentration of reagent in the reactive chamber.

The preferred embodiment of the water extraction apparatus provides for gravity flow of reagent solution from the reactive chamber to the recovery chamber, with the rate of flow of the reactive chamber reagent solution being determined by the rate of water extraction from the recovery chamber by the vacuum pump and the rate of re-circulation of the re-circulated reagent from the recovery chamber to the reactive chamber.

The energy required for the extraction energy exchanger, the recovery vacuum pump, the recovery chamber temperature control pump, and the reagent re-circulation pump will be substantially less than the energy required by a heat exchanger for condensing water directly from the ambient atmosphere. The use of waste heat from an energy source to heat the reagent solution in the recovery chamber enhances this benefit.

Another preferred embodiment of the water extraction apparatus of the present invention can be used to purify raw water. For this embodiment, raw water preferably filtered to remove suspended solids, is fed to the reactive chamber and mixed with the reagent. Sulfuric acid is preferred by the inventor for raw water embodiments, because of the advantages of sulfuric acid which are identified above and because of the inherent characteristics of sulfuric acid to destroy pathogenic organisms and to break down organic compounds in raw water. Because the reaction of the reagent with organic and inorganic compounds in the raw water, makeup reagent is added to the reactive chamber based upon ph measurements from a ph sensor. To maintain desired liquid levels in the reactive chamber and the recovery chamber with the addition of makeup reagent, reagent solution may be extracted periodically from the reactive chamber as spent reagent. Otherwise, embodiments of the water extraction apparatus for the extraction of potable water from raw water have the same components as that used for the extraction of water from ambient air.

The reaction of the raw water with the reagent before the water is extracted from the reagent solution by vacuum in the recovery chamber results in the elimination of pathogens from the water. Hence the probability that pathogens will survive the reactive chamber and the recovery chamber, and penetrate the vaporization process in the recovery chamber, is very low. It is unlikely that chlorination or other disinfectant processes would be required for the extracted water before culinary use, even if the raw water is raw or partially treated sewage water.

### BRIEF DESCRIPTION OF THE DRAWINGS

FIG. 1 is a block diagram flow chart of a preferred embodiment of the water extraction apparatus of the present invention for extracting water from air containing water vapor.

FIG. 2 is a schematic vertical cross-section of a preferred embodiment of the water extraction apparatus of the present invention for extracting water from air containing water vapor.

FIG. 3 is a block diagram flow chart of a preferred embodiment of the water extraction apparatus of the present invention for purifying raw water.

### DETAILED DESCRIPTION

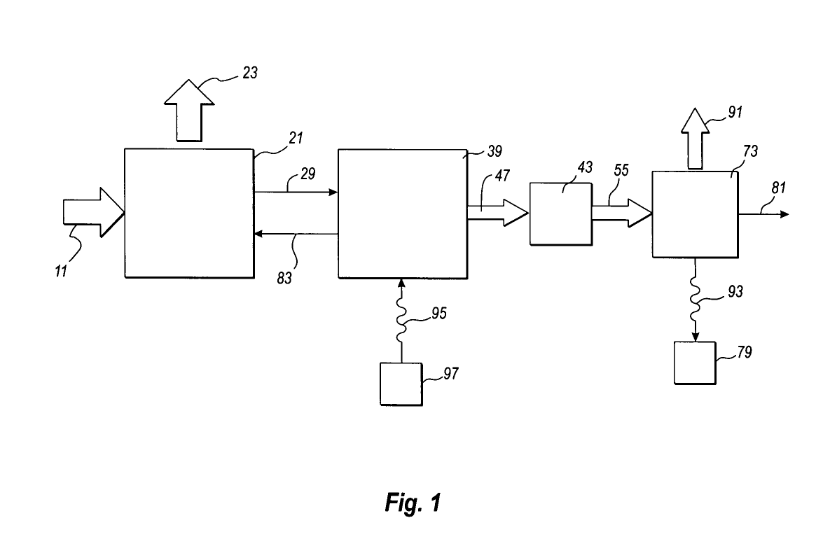

Referring first to FIG. 1, a block diagram flow chart of a preferred embodiment of the water extraction apparatus 1 of the present invention is shown. Pressurized feed air 11 from any source of air, including ambient atmosphere, containing water vapor is supplied to a reactive chamber 21 containing a reagent with water absorption properties. The inventor prefers sulfuric acid as the reagent. The water vapor is absorbed from the pressurized feed air and spent air 23 with most of the water removed is discharged to atmosphere. Reagent solution 29 is transmitted to a recovery chamber 39 where concentrated water vapor is extracted from the reagent solution which is heated by recovery heat 95 supplied from an energy source 97. The concentrated water vapor is extracted in a concentrated vapor zone created by a vacuum pump 43, which also pressurizes concentrated water vapor for an extraction energy exchanger 73 which discharges extracted water 81. Heat of cooling and vaporization 93 is extracted from the extraction energy exchanger by a heat exchange device 79. Concentrated reagent 83 is re-circulated from the recovery chamber to the reactive chamber.

As indicated above, the inventor prefers sulfuric acid as the reagent for the reactive chamber. However, other acids and other reagents with water absorption characteristics which also have a higher vaporization temperature than water for a given pressure can be used. Sulfuric acid is preferred because of its high water absorption capability, high vaporization temperature, high heat of vaporization, and relatively low cost.

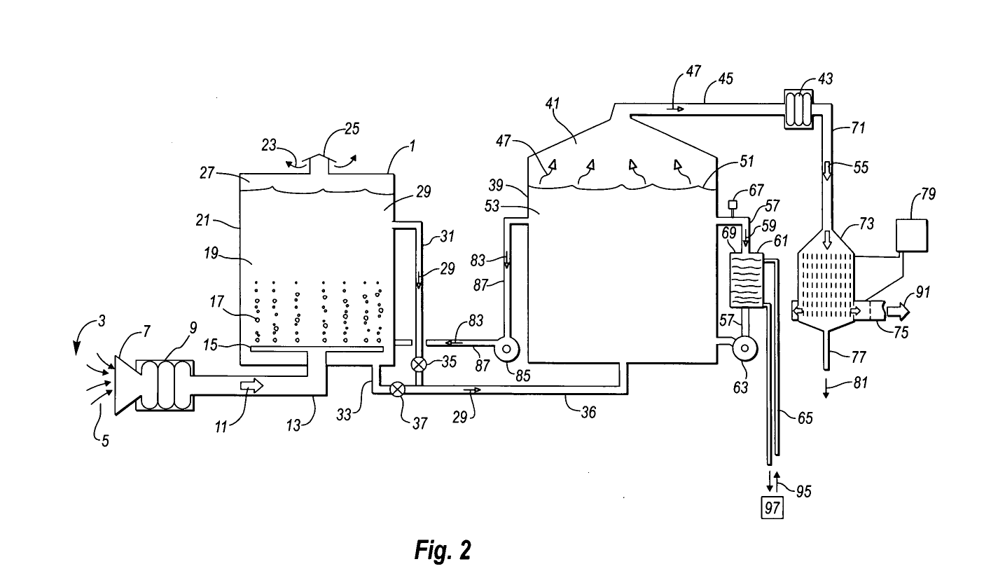

Referring now to FIG. 2, a schematic vertical cross-section of a preferred embodiment of the water extraction apparatus 1 of the present invention is shown. FIG. 2 illustrates the use of the water extraction apparatus for the extraction of water from ambient atmosphere 3. However, the embodiment of the water extraction apparatus shown can be utilized with any source of air containing water vapor, such as spent steam from a steam turbine engine. While the water extraction apparatus will be more efficient with feed air having a high water content, it will extract water from air having a low water content, such as desert air having an average relative humidity of five percent.

Feed air 5 from the ambient atmosphere 3 is pulled into an air intake 7 and is pressurized by intake blowers 9. Pressurized feed air 11 is transmitted by a feed pipe 13 from the intake blowers to a diffuser assembly 15 which diffuses, distributes and mixes diffused feed air 17 with reagent 19 in a reactive chamber 21. If the reagent is sulfuric acid, the acid molecules in the reactive chamber react with the water molecules in the diffused feed air. The water is captured as reagent solution 29, which will be an acid solution if the reagent is sulfuric acid, in the reactive chamber. Spent air 23, which is the diffused feed air with most of the water content of the feed air removed, is released from a reactive chamber vent 25. The spent air will generally have a relative humidity of less than one percent. For the embodiment shown, the reactive chamber has an upper gas segment 27 which is preferably maintained at or above ambient atmospheric pressure. The amount of water lost in the spent air can be reduced by increasing the pressure in the upper gas segment of the reactive chamber. The reactive chamber vent can be controlled to maintain a desired pressure in the upper gas segment.

The diffuser assembly is preferably located near the bottom of the reactive chamber. As an alternative to a diffuser assembly, mechanical mixing or other diffusion means for diffusing, mixing and distributing the pressurized feed air in the reactive chamber will be known to persons skilled in the art. Likewise, other air feed means will be known to persons skilled in the art.

Reagent solution is transmitted to the reagent recovery chamber 39 by an upper reagent solution line 31 or a lower reagent solution line 33, each of which connect to a reactive chamber feed line 36. An upper reagent valve 35 and a lower reagent valve 37 are used to select the upper portion of the reactive tank or the lower portion of the reactive tank for passing reagent solution to the reagent recovery chamber. Either the upper reagent solution line or the lower reagent solution line can be used for continuous transfer to the reagent recovery chamber and the lower reagent solution line can be used for batch transfer of reagent solution to the reagent recovery chamber.

A recovery vacuum pump 43 which is connected to a concentrated vapor zone 41 by a vacuum pipe 45 imposes a vacuum on the recovery chamber liquid surface 51, which results in an accelerated vaporization rate for the water in the reagent solution. Other vacuum means for imposing a vacuum on the recovery chamber liquid surface will be known to persons skilled in the art. The inventor has found that a temperature ranging between 180° Fahrenheit and 200° Fahrenheit for the recovery chamber reagent solution 53 is preferred for optimizing the vaporization of water from the reagent solution in the reagent recovery chamber, if sulfuric acid is used for the reagent. However, other temperatures can be used effectively, even for sulfuric acid, depending on the vacuum imposed in the concentrated vapor zone.

A recovery chamber temperature sensor 67 is used to activate a recovery chamber heat assembly 69 which, for the embodiment shown, includes a recovery chamber temperature control pump 63 which pumps reagent solution 53 from the recovery chamber by a recovery heat line 57 through a recovery heat exchanger 61. The temperature sensor can also be used to control the rate of supply of recovery heat 95 by a heat supply line 65 from an energy source 97. The temperature of the recovery chamber is maintained in a desired temperature range by controlling the rate of circulation of the reagent solution through the recovery chamber heat assembly and the rate of energy supply to the recovery heat assembly. Other recovery chamber heat assemblies 69 and other recovery chamber heat supply means will be known to persons skilled in the art. Waste heat from a steam turbine or other process can be used as an energy source for the recovery chamber heat assembly. A solar collector can also be used to provide a heat source for the recovery chamber heat assembly.

The vacuum imposed by the recovery vacuum pump 43 accelerates the formation of concentrated water vapor 47 in the recovery vapor segment 41 of the recovery chamber. The concentration of water vapor in the recovery vapor segment is substantially higher than the concentration of water vapor in the ambient atmosphere.

The vacuum pump discharges pressurized concentrated water vapor 55 to a concentrated vapor line 71 which carries the pressurized concentrated water vapor to an extraction energy exchanger 73 which condenses water from the pressurized concentrated water vapor. Other extracted water condensation means for condensing the concentrated water vapor will be known to persons skilled in the art. The extracted water 81 can be conveyed by a discharge pipe 77 to a storage tank or directly to a water use application. A number of heat extraction devices 79 for extracting cooling and condensation heat 93 from the pressurized concentrated water vapor in the extraction energy exchanger will be known to persons skilled in the art. No doubt additional advances in technology will also provide additional heat extraction means for condensing the water from the pressurized concentrated water vapor. Discharge air 91 with most of the water vapor removed is discharged from a discharge port 75 in the extraction energy exchanger, thereby dissipating residual pressure.

As water is vaporized from the recovery chamber liquid surface 51 the concentration of the reagent in the recovery chamber is increased. Re-circulated reagent 83 is returned by a reagent re-circulation pump 85 through a reagent re-circulation line 87 to the reactive chamber 21 to maintain hydraulic balance between the reactive chamber and the recovery chamber and to maintain the concentration of reagent in the reactive chamber. Liquid level sensors in the reactive chamber and the recovery chamber can be used to control the reagent re-circulation pump. Other chamber liquid level control means will be known to persons skilled in the art.

The preferred embodiment of the water extraction apparatus shown in FIG. 2 provides for gravity flow of reagent solution from the reactive chamber to the recovery chamber, with the rate of flow of the reactive chamber reagent solution 29 being determined by the rate of water extraction from the recovery chamber by the vacuum pump and the rate of re-circulation of the re-circulated reagent 87 from the recovery chamber to the reactive chamber. Other hydraulic designs, hydraulic interconnection means, and hydraulic control means will be known by persons skilled in the art for the reactive chamber, the recovery chamber, the reagent solution lines between the reactive chamber and the recovery chamber, and for the reagent re-circulation means.

The energy required for the extraction energy exchanger 73, the recovery vacuum pump 43, the recovery chamber temperature control pump 63, and the reagent re-circulation pump 85 will be substantially less than the energy required by a heat exchanger for condensing water directly from the ambient atmosphere. The use of waste heat from an energy source 71 to heat the reagent solution in the recovery chamber enhances this benefit.

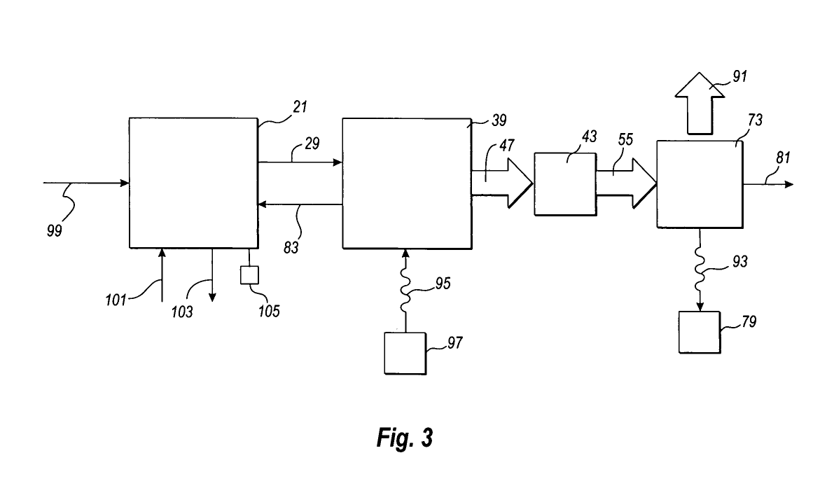

Referring now to FIG. 3, a block diagram flow chart of a preferred embodiment of the water extraction apparatus 1 of the present invention that can be used to purify raw water is shown. This embodiment is very similar to the embodiment shown in FIG. 1. For this embodiment, raw water 99, preferably filtered to remove suspended solids, is fed to the reactive chamber 21 and mixed with the reagent 19. Raw water mixing means for mixing the raw water with the reagent will be known to persons skilled in the art. Diffusers such as that used for feed air for the embodiment shown in FIG. 1 and FIG. 2 could be used for raw water mixing but will generally not be preferred for raw water embodiments. Sulfuric acid is preferred by the inventor for raw water embodiments, because of the advantages of sulfuric acid which are identified above and because of the inherent characteristics of sulfuric acid to destroy pathogenic organisms and to break down organic compounds in raw water. Because the reaction of the reagent with organic and inorganic compounds in the raw water results in a gradual decrease in the reactive chamber of the ph of the reagent solution, if an acid is used, or in a gradual effective decrease in reagent concentration for all reagents, and the concentrated reagent in the recovery chamber, makeup reagent 101 is added to the reactive chamber based upon ph measurements from a ph sensor 105. To maintain desired liquid levels in the reactive chamber and the recovery chamber with the addition of makeup reagent, reagent solution may be extracted periodically from the reactive chamber as spent reagent 103. Otherwise, the water extraction apparatus shown in FIG. 3 has the same components as that used for the extraction of water from ambient air as shown in FIG. 1 and FIG. 2. Of course, sizing of components is dependent on the quantity of raw water to be processed. The extracted water 81 for this embodiment will be potable water, having a quality that is close to the quality of distilled water.

The reaction of the raw water with the reagent before the water is extracted from the reagent solution by vacuum in the recovery chamber results in the elimination of pathogens from the water. Hence the probability that pathogens will survive the reaction process and the long term exposure to the reagent in the reactive chamber and the recovery chamber, and penetrate the vaporization process in the recovery chamber, is very low. It is unlikely that chlorination or other disinfectant processes would be required for the extracted water before culinary use, even if the raw water is raw or partially treated sewage water. Again, the removal of solids from the raw water before being fed to the reactive chamber is preferable as the buildup of solids in the reactive chamber or the recovery chamber is undesirable. While embodiments could provide for the handling of solids which might settle out in the reactive chamber or the recovery chamber, those embodiments are not preferable.

Other embodiments and other variations of the embodiments described above will be obvious to a person skilled in the art. Therefore, the foregoing is intended to be merely illustrative of the invention and the invention is limited only by the following claims and the doctrine of equivalents.

1. Water extraction apparatus for extracting liquid water from feed air containing water vapor, the apparatus comprising:
a) reactive chamber;
b) feed air means for feeding feed air to the reactive chamber;
c) diffusion means for distributing, diffusing and mixing feed air in reagent in the reactive chamber, thereby forming reagent solution;
d) recovery chamber hydraulically connected to the reactive chamber;
e) vacuum means for imposing a vacuum in a concentrated vapor zone in the recovery chamber and evaporating concentrated water vapor from the reagent solution, thereby forming concentrated reagent in the recovery chamber; and
f) condensation means for condensing the concentrated water vapor extracted from reagent solution in the recovery chamber concentrated vapor zone.

2. Apparatus as recited in claim 1 further comprising reagent re-circulation means for recirculating concentrated reagent from the recovery chamber to the reactive chamber.

3. Apparatus as recited in claim 1 further comprising a recovery chamber heat assembly.

4. Apparatus as recited in claim 3 wherein the recovery chamber heat assembly comprises a heat source, a heat transfer element, a temperature control element, a reagent feed conduit, and a heated reagent conduit to the reactive chamber.

5. Apparatus as recited in claim 1 wherein the reactive chamber comprises a sealed reactive tank with a liquid zone and a vapor zone.

6. Apparatus as recited in claim 1 wherein the feed air means comprises an air intake, an air pressurization element, and a feed air connection to the diffusion means.

7. Apparatus as recited in claim 1 wherein the reactive chamber has a bottom and the diffusion means comprises a diffuser assembly mounted in the reactive chamber proximal to the bottom of the reactive chamber, the diffuser assembly being hydraulically connected to the feed air means.

8. Apparatus as recited in claim 1 wherein the recovery chamber comprises a sealed recovery tank with a liquid zone and a concentrated vapor zone.

9. Apparatus as recited in claim 1 wherein the vacuum means comprises a vacuum pump and a concentrated vapor line, the vacuum pump having a vacuum intake and a pressure discharge, the concentrated vapor line connecting the vacuum pump intake to the concentrated vapor zone in the recovery chamber and connecting the vacuum pump discharge to the condensation means.

10. Apparatus as recited in claim 1 wherein the condensation means comprises an extraction energy exchanger.

11. Apparatus as recited in claim 1 wherein the reagent is sulfuric acid.

12. Water extraction apparatus for extracting liquid water from feed air containing water vapor, the apparatus comprising:
a) reactive chamber;
b) feed air diffuser affixed in the reactive chamber;
c) feed air assembly comprising a feed air intake, feed air blower, and feed air pipe to the feed air diffuser in the reactive chamber;
d) recovery chamber hydraulically connected to the reactive chamber, the recovery chamber having a liquid zone and a concentrated vapor zone;
e) reagent re-circulation assembly hydraulically connecting the recovery chamber liquid zone to the reactive chamber;
g) vacuum pump having a vacuum intake and a pressure discharge;
h) extraction energy exchanger; and
i) concentrated vapor line connecting the vacuum pump intake to the concentrated vapor zone in the recovery chamber and connecting the vacuum pump discharge to the extraction energy exchanger.

13. Apparatus as recited in claim 12 further comprising a recovery chamber heat assembly.

14. Apparatus as recited in claim 13 wherein the recovery chamber heat assembly comprises a heat source, a heat transfer element, a temperature control element, a reagent feed conduit, and a heated reagent conduit to the reactive chamber.

15. Apparatus as recited in claim 12 wherein the reactive chamber comprises a sealed reactive tank with a liquid zone and a vapor zone.

16. Apparatus as recited in claim 12 wherein the reactive chamber comprises a sealed reactive tank with a liquid zone and a vapor zone.

17. Apparatus as recited in claim 12 wherein the reactive chamber is hydraulically connected to the recovery chamber by a reagent solution line.

18. Apparatus as recited in claim 12 wherein the reagent re-circulation assembly comprises a reagent re-circulation line and a reagent re-circulation pump.

19. Water extraction apparatus for extracting potable water from raw water comprising:
a) reactive chamber;
b) raw water feed means for feeding raw water to reagent in the reactive chamber, thereby forming a reagent solution in the reactive chamber;
c) recovery chamber hydraulically connected to the reactive chamber;
d) vacuum means for imposing a vacuum in a concentrated vapor zone in the recovery chamber and evaporating concentrated water vapor from the reagent solution, thereby forming concentrated reagent in the recovery chamber; and
e) condensation means for condensing the concentrated water vapor extracted from reagent solution in the recovery chamber concentrated vapor zone.

20. Apparatus as recited in claim 19 further comprising raw water mixing means for mixing raw water in reagent in the reactive chamber.

21. Apparatus as recited in claim 20 wherein the raw water mixing means is a mechanical mixer affixed in the reactive chamber.

22. Apparatus as recited in claim 19 further comprising reagent re-circulation means for recirculating concentrated reagent from the recovery chamber to the reactive chamber.

23. Apparatus as recited in claim 19 further comprising a recovery chamber heat assembly.

24. Apparatus as recited in claim 23 wherein the recovery chamber heat assembly comprises a heat source, a heat transfer element, a temperature control element, a reagent feed conduit, and a heated reagent conduit to the reactive chamber.

25. Apparatus as recited in claim 20 wherein the reactive chamber comprises a sealed reactive tank with a liquid zone and a vapor zone.

26. Apparatus as recited in claim 19 wherein the raw water feed means comprises a raw water line hydraulically connected to the reactive chamber.

27. Apparatus as recited in claim 19 wherein the reactive chamber has a bottom and the diffusion means comprises a diffuser assembly mounted in the reactive chamber proximal to the bottom of the reactive chamber, the diffuser assembly being hydraulically connected to the feed air means.

28. Apparatus as recited in claim 19 wherein the recovery chamber comprises a sealed recovery tank with a liquid zone and a concentrated vapor zone.

29. Apparatus as recited in claim 19 wherein the vacuum means comprises a vacuum pump and a concentrated vapor line, the vacuum pump having a vacuum intake and a pressure discharge, the concentrated vapor line connecting the vacuum pump intake to the concentrated vapor zone in the recovery chamber and connecting the vacuum pump discharge to the condensation means.

30. Apparatus as recited in claim 19 wherein the condensation means comprises an extraction energy exchanger.

31. Apparatus as recited in claim 19 wherein the reagent is sulfuric acid.

32. Water extraction apparatus for extracting potable water from raw water comprising:
a) reactive chamber;
b) raw water feed pipe to the reactive chamber;
c) recovery chamber hydraulically connected to the reactive chamber, the recovery chamber having a liquid zone and a concentrated vapor zone;
d) reagent re-circulation assembly hydraulically connecting the recovery chamber liquid zone to the reactive chamber;
e) vacuum pump having a vacuum intake and a pressure discharge;
f) extraction energy exchanger; and
g) concentrated vapor line connecting the vacuum pump intake to the concentrated vapor zone in the recovery chamber and connecting the vacuum pump discharge to the extraction energy exchanger.

33. Apparatus as recited in claim 32 further comprising raw water mixing means for mixing raw water in reagent in the reactive chamber.

34. Apparatus as recited in claim 33 wherein the raw water mixing means is a mechanical mixer affixed in the reactive chamber.

35. Apparatus as recited in claim 32 wherein the reactive chamber is hydraulically connected to the recovery chamber by a reagent solution line.

36. Apparatus as recited in claim 32 wherein the reagent re-circulation assembly comprises a reagent re-circulation line and a reagent re-circulation pump,

37. Apparatus as recited in claim 32 further comprising a recovery chamber heat assembly.

38. Apparatus as recited in claim 37 wherein the recovery chamber heat assembly comprises a heat source, a heat transfer element, a temperature control element, a reagent feed conduit, and a heated reagent conduit to the reactive chamber.

39. Apparatus as recited in claim 32 wherein the reactive chamber comprises a sealed reactive tank with a liquid zone and a vapor zone.

40. Apparatus as recited in claim 32 wherein the reactive chamber comprises a sealed reactive tank with a liquid zone and a vapor zone.

41. Apparatus as recited in claim 32 wherein the reactive chamber is hydraulically connected to the recovery chamber by a reagent solution line.

42. Method for extracting liquid water from feed air containing water vapor comprising the steps of:
a) feeding the feed air to a reactive chamber containing a reagent;
b) diffusing the feed air in the reagent in the reactive chamber, thereby forming reagent solution;
c) releasing from the reactive chamber as spent air the feed air with a portion of the water vapor removed;
d) transmitting reagent solution to a recovery chamber;
e) imposing a vacuum in a concentrated vapor zone in the recovery chamber, thereby evaporating concentrated water vapor from the reagent solution and forming concentrated reagent in the recovery chamber; and
f) condensing the concentrated water vapor extracted from reagent solution in the recovery chamber concentrated vapor zone.

43. Method as recited in claim 42 further comprising a step of recirculating concentrated reagent from the recovery chamber to the reactive chamber.

44. Method as recited in claim 42 further comprising a step of heating the reagent solution in the recovery chamber to maintain the reagent solution in a desired temperature range.

45. Method as recited in claim 44 wherein the step of heating the reagent solution is accomplished with a recovery chamber heat assembly comprising a heat source, a heat transfer element, a temperature control element, a reagent feed conduit, and a heated reagent conduit to the reactive chamber.

46. Method as recited in claim 42 wherein the step of feeding feed air to the reactive tank is accomplished with an air intake, an air pressurization element, and a feed air connection to the diffusion means.

47. Method as recited in claim 42 wherein the step of diffusing feed air in the reactive chamber is accomplished with a diffuser assembly mounted in the reactive chamber proximal to the bottom of the reactive chamber.

48. Method as recited in claim 42 wherein the step of imposing a vacuum in a concentrated vapor zone in the recovery chamber is accomplished with a sealed recovery tank with a liquid zone and a concentrated vapor zone and a vacuum pump and a concentrated vapor line, the vacuum pump having a vacuum intake and a pressure discharge, the concentrated vapor line connecting the vacuum pump intake to the concentrated vapor zone in the recovery chamber.

49. Method as recited in claim 42 wherein the step of condensing the concentrated water vapor is accomplished with an extraction energy exchanger.

50. Method as recited in claim 42 wherein the reagent is sulfuric acid.

51. Method for extracting potable water from raw water comprising the steps of:
a) feeding the raw water to a reactive chamber containing a reagent, thereby forming a reagent solution;
b) transmitting reagent solution to a recovery chamber;
c) imposing a vacuum in a concentrated vapor zone in the recovery chamber, thereby evaporating concentrated water vapor from the reagent solution and forming concentrated reagent in the recovery chamber; and
d) condensing the concentrated water vapor extracted from reagent solution in the recovery chamber concentrated vapor zone.

52. Method as recited in claim 51 further comprising a step of recirculating concentrated reagent from the recovery chamber to the reactive chamber.

53. Method as recited in claim 51 further comprising a step of heating the reagent solution in the recovery chamber to maintain the reagent solution in a desired temperature range.

54. Method as recited in claim 53 wherein the step of heating the reagent solution is accomplished with a recovery chamber heat assembly comprising a heat source, a heat transfer element, a temperature control element, a reagent feed conduit, and a heated reagent conduit to the reactive chamber.

55. Method as recited in claim 51 further comprising the step of mixing the raw water with the reagent in the reactive chamber.

56. Method as recited in claim 51 wherein the step of imposing a vacuum in a concentrated vapor zone in the recovery chamber is accomplished with a sealed recovery tank with a liquid zone and a concentrated vapor zone and a vacuum pump and a concentrated vapor line, the vacuum pump having a vacuum intake and a pressure discharge, the concentrated vapor line connecting the vacuum pump intake to the concentrated vapor zone in the recovery chamber.

57. Method as recited in claim 51 wherein the step of condensing the concentrated water vapor is accomplished with an extraction energy exchanger.

58. Method as recited in claim 51 wherein the reagent is sulfuric acid.
